(19) United States
(12) Patent Application Publication
(10) Pub. No.: US 2008/0270293 A1
(43) Pub. Date: Oct. 30, 2008

(54) Accounts payable automation system with automated discount and factoring management

(75) Inventors: Peter Stanley Fortune, Reading (GB); Nigel Kevin Savory, Bath (GB); Gareth Rory Priest, Reading (GB); Christopher Curtis Martin, Portsmouth, NH (US)

Correspondence Address: TIMOTHY P. O'HAGAN, 8710 KILKENNY CT, FORT MYERS, FL, 33912, US

(73) Assignee: Bottomline Technologies (DE) Inc., Portsmouth, NH (US)

(21) Appl. No.: 11/789,952

(22) Filed: Apr. 26, 2007

(51) Int. Cl. G06Q 40/00; G06Q 90/00

(52) U.S. Cl. 705/38; 705/40

(57) ABSTRACT

An accounts payable automation server system with integrated discount and factoring management, the system comprises an invoice loader receiving invoice data. The invoice data includes at least a vendor element and an amount payable element. The vendor element identifies a vendor and the amount payable element identifies consideration payable by the customer to the vendor. Customer user access workflows present, to a customer system, the invoice data. Finance company user access workflows: i) present, to a finance system, the vendor element and the amount payable element; and ii) receive, from the finance system, an offer of early payment in exchange for a discount of the consideration payable. Vendor user access workflows: i) present, to the vendor system, the offer of early payment in exchange for a discount of the consideration payable; and ii) receive an acceptance of the offer from the vendor system. The finance company user access workflows further, upon acceptance of the offer, present, to the finance system, an indication of the acceptance of the offer. Further, upon payment of a discounted amount from the finance company to the vendor, a direction to transfer payment of the consideration to the finance company is recorded.

### TECHNICAL FIELD

The present invention relates to financial transaction management, and more particularly, to an invoice transaction system with finance company access for automated discount and factoring management.

### BACKGROUND OF THE INVENTION

Various internet-based electronic invoice processing systems are known in the art whereby a vendor can electronically present a bill to a customer for review. It is envisioned that such electronic systems would displace traditional paper-based billing systems wherein a vendor prints and mails an invoice to a customer.

However, widely divergent accounts receivables systems and accounts payables systems have prevented electronic invoicing from becoming ubiquitous. Even with development of standards such as EDI and XML, extensive customization is needed to configure the interface between each vendor and each customer accounting system for the exchange of invoice data. As a result, only customers with considerable influence over their vendors have been able to persuade the majority of their vendors to comply with their electronic invoicing requirements.

Due to the structural problems inherent to electronic invoicing, the most common means for a vendor to send invoice data to a customer remains: i) traditional printing and mailing of a paper invoice to the customer; and ii) generation of an electronic image (such as PDF, Tiff, or other) of an invoice (e.g. an electronic image representation of a printed invoice) for emailing to the customer.

Manual data entry remains the most common means for a customer to enter invoice data into its accounting systems. If a paper invoice is received, a human operator will typically key the invoice data into manual data entry (MDE) screens of the accounting system. If an electronic image (PDF, Tiff, or other) of an invoice is received, it is typically printed to paper form and then a human operator keys the invoice data into the MDE screens of the accounting system.

Accordingly, there is a need in the art for an invoice transaction system for automating the process of receiving invoice data. Further, what is needed is for such system to facilitate financing of a vendor's accounts receivables by a third party finance company.

### SUMMARY OF THE INVENTION

A first aspect of the present invention comprises accounts payable automation server system for exchanging invoice data between a vendor, a customer, and a third party finance company to automate discount and factoring management. The system comprises an invoice loader receiving invoice data. The invoice data may include at least a vendor element and an amount payable element. The vendor element identifies a vendor and the amount payable element identifies consideration payable by the customer to the vendor.

A session management engine operates as a web server and may comprise customer user access workflows, finance company user access workflows, and vendor user access workflows. The customer user access workflows may present the invoice data to a customer system. The customer system may be a system controlled by the customer such as a web browser through which a customer representative is accessing the server utilizing a user access account associated with the customer.

The finance company user access workflows: i) present, to a finance system, the vendor element and the amount payable element; and ii) receive, from the finance system, an offer of early payment in exchange for a discount of the consideration payable. The finance company system may be a system controlled by the finance company such as a web browser through which a finance company representative is accessing the server utilizing a user access account associated with the finance company.

The vendor user access workflows: i) present, to the vendor system, the offer of early payment in exchange for a discount of the consideration payable; and ii) receiving an acceptance of the offer from the vendor system. The vendor system may be a system controlled by the vendor such as a web browser through which a vendor representative is accessing the server utilizing a user access account associated with the vendor.

The finance company user access workflows further, upon acceptance of the offer, present, to the finance system, an indication of the acceptance of the offer.

The session management engine further, upon payment of a discounted amount from the finance company to the vendor, records a direction to transfer payment of the consideration to the finance company.

In one sub embodiment, the system may further generate a payment transaction upon receipt of an acceptance of the offer from the vendor system. The payment transaction comprises an instruction to affect debit from an account corresponding to the finance system of the discounted amount (e.g. consideration less the discount) and to affect a corresponding credit to an account corresponding to the vendor system.

In other embodiments, the customer user access workflows may receive, from the customer system, an indication of the approval status for association with the vendor element and the amount payable element of the invoice (at an invoice level or line item level).

For example, the approval status may be a matched-to-purchase-order approval status indicating that the consideration corresponds to the price set forth in a purchase order issued by the customer. A final approval status within a multi-level approval system may be a scheduled-for-payment status wherein the customer has schedule a payment to the vendor for the invoice or line item. Approvals may be at the invoice level or the line item level.

Approval at certain levels may be automated. For example, the system may further: i) receive purchase order data from the customer system representing a plurality of purchase orders issued by the customer; and ii) compare the invoice data with the purchase order data to generate the matched-to-purchase-order approval status when the invoice data matches the purchase order data for one of the plurality of purchase orders.

The finance company user access workflows may further present, to the finance system, in association with the vendor element and the amount payable element, a customer approval status indicator identifying an approval status within a multi-tiered approval process. This enables the finance company to make factoring offers based on the customer's approval status of an invoice.

An email alert system may generate an approval status update email to an email address associated with the finance system when the approval status associated with an invoice or line item changes. In more detail, the approval status update email may indicate a change of the approval status associated with the vendor element and the amount payable element. The change of status may be an indication that the invoice or line item has achieved the next level of approval within a multi-level approval system.

For example, the email alert system may generate an approval status update email to the email address associated with the finance system when matched-to-purchase-order approval status is achieved and/or scheduled-for-payment approval status is achieved.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 is a block diagram of an automated invoice transaction system in accordance with one embodiment of the present invention;

FIG. 2 is a diagram representing exemplary invoice data in accordance with one embodiment of the present invention;

FIG. 3a is a diagram representing fields of an invoice summary table of a database in accordance with one embodiment of the present invention;

FIG. 3b is a diagram representing fields of a line item table of a database in accordance with one embodiment of the present invention;

FIG. 3c is a diagram representing fields of a line item approval table of a database in accordance with one embodiment of the present invention;

FIG. 3d is a diagram representing fields of an assignment table of a database in accordance with one embodiment of the present invention;

FIG. 3e is a diagram representing fields of an automatic offer table of a database in accordance with one embodiment of the present invention;

FIG. 3f is a diagram representing fields of access table of a database in accordance with one embodiment of the present invention;

FIG. 3g is a diagram representing fields of an offer table of a database in accordance with one embodiment of the present invention;

FIG. 4 is a flow chart representing exemplary operation of one aspect of a customer workflow in accordance with one embodiment of the present invention;

FIG. 5 is a web document diagram representing a document image in accordance with one embodiments of the present invention;

FIG. 6 is a flow chart representing exemplary operation of one aspect of a customer workflow in accordance with one embodiment of the present invention;

FIG. 7 is a flow chart representing exemplary operation of one aspect of a customer workflow in accordance with one embodiment of the present invention;

FIG. 8 is a flow chart representing exemplary operation of one aspect of a finance company workflow in accordance with one embodiment of the present invention;

FIG. 9 is a web document diagram representing a document image in accordance with one embodiments of the present invention;

FIG. 10 is a flow chart representing exemplary operation of one aspect of a finance company workflow in accordance with one embodiment of the present invention;

FIG. 11 is a web document diagram representing a document image in accordance with one embodiments of the present invention;

FIG. 12 is a flow chart representing exemplary operation of one aspect of a vendor workflow in accordance with one embodiment of the present invention;

FIG. 13 is a web document diagram representing a document image in accordance with one embodiments of the present invention;

FIG. 14 is a block diagram representing an exemplary document image and workflow system in accordance with one embodiment of the present invention;

FIG. 15 is a diagram representing an exemplary invoice image in accordance with one embodiment of the present invention;

FIG. 16 is a table diagram representing an aspect of dematerializing in accordance with one embodiment of the present invention;

FIG. 17 is a table diagram representing an aspect of dematerializing in accordance with one embodiment of the present invention;

FIG. 18 is a table diagram representing an aspect of dematerializing in accordance with one embodiment of the present invention; and

FIG. 19 is a web document diagram representing a document image in accordance with one embodiments of the present invention.

### DETAILED DESCRIPTION OF THE INVENTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should be emphasized that the term “comprises/comprising” and or “includes/including” when used in this specification is taken to specify the presence of stated features, integers, steps or components but does not preclude the presence or addition of one or more other features, integers, steps, components or groups thereof.

It should also be appreciated that many of the elements discussed in this specification may be implemented in hardware circuit(s), a processor executing software code, or a combination of a hardware circuit and a processor executing code. As such, the term circuit as used throughout this specification is intended to encompass a hardware circuit (whether discrete elements or an integrated circuit block), a processor executing code, or a combination of a hardware circuit and a processor executing code, or other combinations of the above known to those skilled in the art.

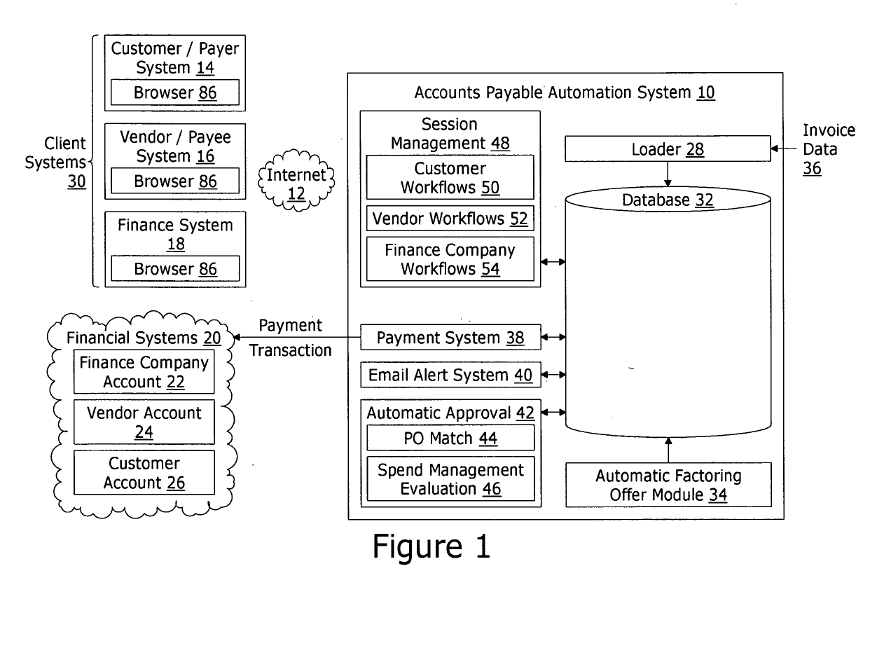

FIG. 1 illustrates exemplary architecture of an accounts payable automation system 10 in accordance with one embodiment of the present invention.

The accounts payable automation system 10 receives invoice data 36 (representing invoices submitted from each of a plurality of vendor/payees to each of a plurality of customer/payers) and includes a loader module 28 for loading the invoice data 36 to a database 32.

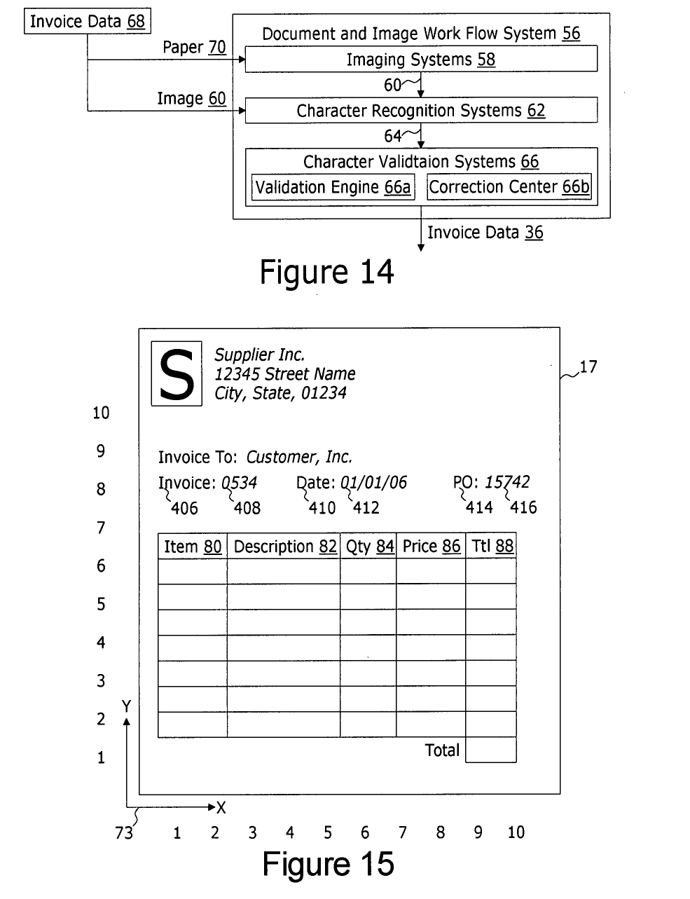

In exemplary embodiments the invoice data 36 may be: i) received as electronic files from the vendor/payee; or ii) received as an electronic file generated by a document and image workflow system 56 (FIG. 14) which obtains invoice data from invoice documents (either paper document or an electronic image document such as a PDF document) by a process referred to as dematerialization.

In general, the system 10 makes the invoice data 36 from the database 32 available to the customer/payer; facilitates and/or automates the customer/payer's invoice approval and payment processes (generally referred to accounts payable processes); provides information related to the approval status of invoices to the vendor/payee submitting the invoice; provides certain invoice data to one or more third party finance companies; facilitates and/or automates the finance company's ability to offer early payment on invoices (or line items) to the vendor/payee in exchange for a discount; enables acceptance of early payment offers by the vendor/payee; and may initiate payment from a finance company account an account of the vendor/payee on acceptance of such an offer.

In more detail, a session management engine 48 which operates as a web server providing workflows to entitled users (e.g. users with an applicable user access account) with access to the system 10. Exemplary user groups include customer/payers, vendor/payees, and finance companies.

As such, the session management engine 48 includes customer/payer workflows 50 which enable entitled users of each customer/payer user group to perform customer/payer tasks. For purposes of illustrating the present invention, the customer/payer tasks may include: i) viewing/approving invoices; ii) downloading an invoice file; iii) uploading a PO file; and iv) uploading an approval data file and v) performing other traditional accounts payable processes.

The session management engine 48 includes vendor/payee workflows 52 which enable entitled users of each vendor/payees user group to perform vendor/payee tasks. For purposes of illustrating the present invention, the vendor/payee tasks may include viewing the approval status of submitted invoices and viewing/accepting factoring offers made by third party financiers.

The session management engine 48 includes finance company workflows 54 which enable entitled users of each finance company to perform finance company tasks. For purposes of illustrating the present invention, the finance company tasks may include: i) viewing the approval status of submitted invoices and entering factoring offers; and ii) configuring auto factoring parameters for use by an auto factoring offer module 34—which automatically generates factoring offers based on the customer/payer's approval status of an invoice/line item.

Each entitled user accesses the system 10 using a browser 86 of a client system 30. To facilitate discussion: i) a client system 30 from which an entitled user of a customer/payer user group accesses customer/payer workflows 50 may be referred to as a customer/payer system 14; ii) a client system 30 from which an entitled user of a vendor/payee user group accesses vendor/payee workflows 52 may be referred to as a vendor/payee system 16; and iii) a client system 30 from which an entitled user of a finance company user group accesses finance company workflows 54 may be referred to as a finance company system 18.

To support the workflows of the session management engine 48, the accounts payable automation system 10 may further comprise an automatic approval system 42, an automatic factoring offer module 34, an email alert system 40, and a payment system 38.

In general, the automatic approval module 42 may automate the approval of certain invoices or, in a multi-level approval process, automate certain levels of approval. In more detail, the auto approval module 42 may include a PO match module 44 and a spend management evaluation module 46.

The PO match module 44 may automatically match line items of submitted invoices with uploaded customer purchase order data to generate a matched-to-purchase-order status for a line item. Matching a line item to a purchase order may be a threshold criteria, or approval, in a multi-level approval process.

The spend management evaluation engine 46 may automatically approve invoices or line items based on preconfigured evaluation parameters in accordance with the teachings of U.S. patent application Ser. No. 11/638,621, filed on Dec. 13, 2006 and entitled Electronic Transaction Processing Server with Automated Transaction Evaluation. Such US Patent Application is commonly assigned with the present application and is hereby incorporated by reference.

The automatic factoring offer module 34 may automatically generate offers of early payment on invoices (or line items) to the vendor/payee in exchange for a discount based on criteria defined by the finance company. A more detailed discussion of the finance company workflows for configuring offer criteria and operation of the offer module 34 are included herein.

The email alert system 40 may provide email alerts of vendor/payee's when: i) approval status of an invoice has changed; and/or ii) when a finance company (or the auto factoring offer module 34) has offered to factor an invoice or line item.

The payment system 38 may generate a payment transaction for transmission to financial systems 20 which effects payment from a finance company account 22 to a vendor account 24 (e.g. debiting an account associated with the finance company making a factoring offer and correspondingly crediting an account associated with the vendor/payee accepting the factoring offer).

### Invoice Loading

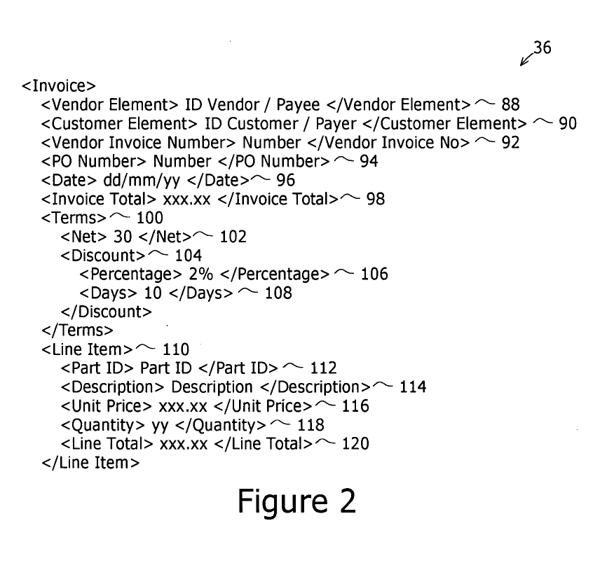

Turning briefly to FIG. 2, invoice data 36 may, as an example, be received by the loader 28 in the form of an XML file wherein various data elements or values are identified by data element tags.

The exemplary XML file may be generated by a vendor/payee and transmitted to the loader 28. Alternatively, if the vendor/payee generates a traditional paper invoice or an image file (e.g. PDF) invoice, the exemplary XML file may be generated by a document and image capture workflow system 56 (FIG. 14) which is discussed later herein.

The exemplary invoice data 36 comprises: i) a vendor element 88 which identifies the vendor/payee issuing the invoice; and ii) a customer element 90 which identifies the customer/payer to which the invoice is sent.

The exemplary invoice data 36 further comprises elements defining: i) a vendor invoice number 92; ii) purchase order number 94; iii) invoice date 96; iv) an invoice total (consideration payable to the vendor expressed as a sum of the line items); v) payment terms 100; and vi) line items 110.

The payment terms 100 may comprise elements defining payment terms for payment of the net amount of the consideration (element 102) and one or more discount terms 104. Each discount term element 104 may include elements defining the discount (element 106) and the turn for which the discount applies (element 108).

Each line item element 110 may comprise elements defining: i) identification of the part, good, or service provided by the vendor (element 112); ii) a description 114; iii) a unit price 116; iv) a quantity provided by the vendor 118; and a total price 120 defining consideration payable to the vendor for the parts, goods, services, or other represented by the line item element 110.

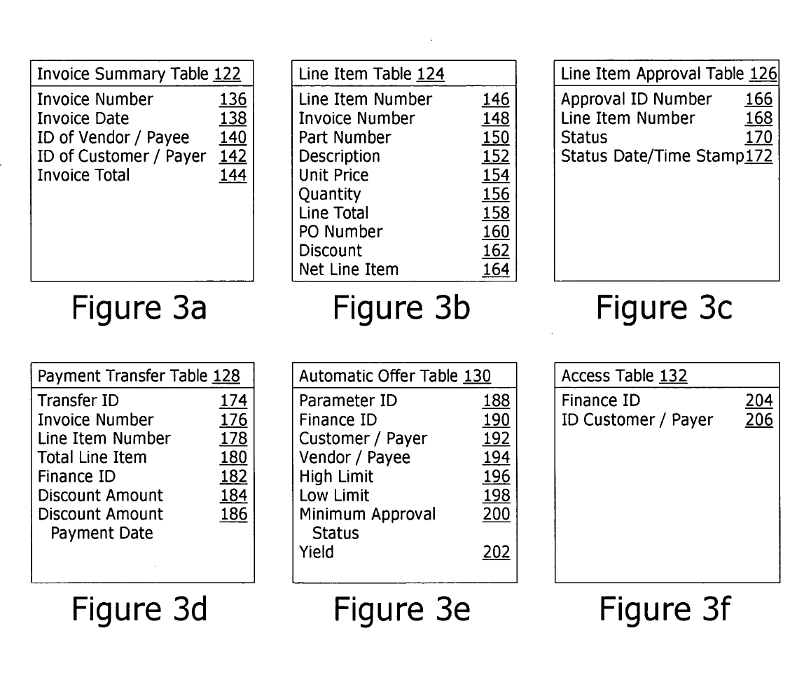

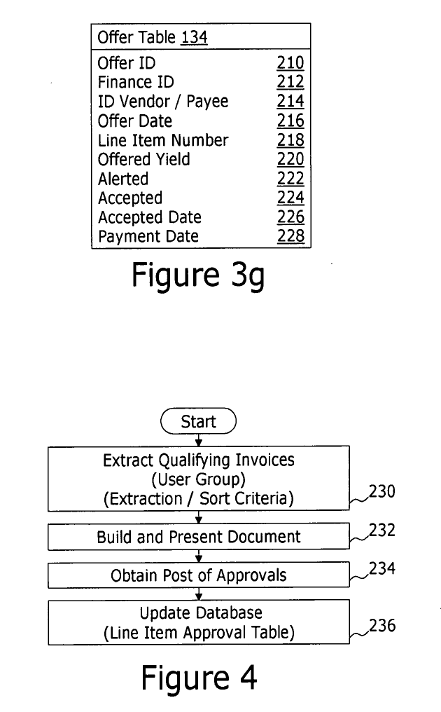

Returning to FIG. 1, the loader populates the data elements from the invoice data 36 into a database 32. Selection of a database schema useful for practice of the present invention is a matter of design choice. For purposes of illustration, the database schema represented by FIGS. 3a-3g may be used.

Turning to FIG. 3a in conjunction with FIG. 2, an exemplary invoice summary table 122 includes an invoice number field 136 into which is populated a unique invoice number for identification of an invoice. The invoice number field 136 may be the index field for the invoice summary table 122.

Associated with the unique invoice number may be: i) an invoice date field 138 into which is populated the date element 96; ii) an ID of vendor/payee field 140 into which the vendor element 88 is populated; iii) an ID of customer/payer field 142 into which the customer element 90 is populated; and iv) an invoice total field 144 into which the invoice total element 98 is populated.

Turning to FIG. 3b in conjunction with FIG. 2, an exemplary line item table 124 includes a line item field 146 into which is populated a unique line item number for identification of a line item. The line item field 146 may be the index field for the line item table 124.

Associated with the unique line item number may be an invoice number field 148 into which is populated the unique invoice number assigned to the invoice which includes the line item (e.g. the value of the invoice number field 136 of the invoice summary table 122). Also associated with the unique line item number may be: i) a part number field 150 into which the part ID element 122 is populated; ii) a description field 122 into which the description element 114 is populated; iii) a unit price field 154 into which the unit price element 116 is populated; iv) a quantity field 156 into which the quantity element 118 is populated; v) a line total field 158 into which the line total element 120 is populated.

Further, for purposes of implementing the present invention, a purchase order field 160; a discount field 162, and a net line item field 164 may be associated with the unique line item number. The values populated into these fields are discussed herein.

Turning to FIG. 3c in conjunction with FIG. 2, an exemplary line item approval table 124 includes an approval ID number field 166 into which a unique approval ID number is populated for identification of an approval transaction. The approval ID number field 166 may be the index field for the line item approval table 126.

Associated with the unique approval ID number may be a line item number field 168 into which the unique line item number assigned to the line item is populated (e.g. the value of the line item number field 146 of the line item table 124). Also associated with the unique approval ID number may be: i) a status field 170 into which one of a plurality of predetermined status identifies (discussed herein) is populated; and ii) a status date/time stamp field 172 into which a date and time of the status update (discussed herein) is populated.

Turning to FIG. 3d in conjunction with FIG. 2, an exemplary line item approval table 124 includes an approval ID number field 166 into which a unique approval ID number is populated for identification of an approval transaction. The approval ID number field 166 may be the index field for the line item approval table 126.

Associated with the unique approval ID number may be a line item number field 168 into which the unique line item number assigned to the line item is populated (e.g. the value of the line item number field 146 of the line item table 124). Also associated with the unique approval ID number may be: i) a status field 170 into which one of a plurality of predetermined status identifies (discussed herein) is populated; and ii) a status date/time stamp field 172 into which a date and time of the status update (discussed herein) is populated.

Turning to FIG. 3d in conjunction with FIG. 2, an exemplary payment transfer table 128 includes an transfer ID number field 174 into which a unique transfer identifier number is populated for identification of a transfer transaction. The transfer ID number field 174 may be the index field for the payment transfer table 128.

Associated with the unique transfer ID number may be a line item number field 176 into which the unique line item number assigned to the line item is populated (e.g. the value of the line item number field 146 of the line item table 124). Also associated with the unique transfer ID number may be: i) total line item field 180 into which is populated the undiscounted amount the customer is to pay (e.g. the consideration); ii) a finance ID field 182 into which is populated identification of the finance company making the payment of the discounted amount to the vendor; iii) a discount amount field 184 into which is populated the discounted payment amount; and iv) a discount amount payment date field 186 into which is populated the payment date of the discounted amount from the finance company to the vendor.

Turning to FIG. 3e in conjunction with FIG. 2, an exemplary automatic offer table 130 includes a parameter ID field 188 into which a unique parameter identifier number is populated for identification of a set of automatic offer parameters. The parameter ID field 188 may be the index field for the automatic offer table 130.

Associated with the unique parameter identifier number may be: i) a finance ID field 190 into which identification of a finance company is populated; ii) a customer /payer ID field 192 into which identification of a customer/payer to which the parameter set applies may be populated; iii) a vendor/payee ID field 194 into which identification of a vendor/payee to which the parameter set applies may be populated; iv) a high limit field 196 into which a maximum automatic factoring value may be populated; v) a low limit field 198 into which a minimum automatic factoring value may be populated; vi) a minimum status approval field 200 into which a value indicating the minimum line item (or invoice) approval status may be populated; and vii) a yield field 202 into which a yield value for calculating a discount may be populated.

Turning to FIG. 3f in conjunction with FIG. 2, an exemplary access table 132 includes an finance ID field 204 and a ID customer/payer field 206 into which identification of a finance company and identification of a customer/payer are populated for purposes of identifying those customer/payers whose invoices the finance company is entitled to view.

Turning to FIG. 3g in conjunction with FIG. 2, an exemplary offer table 134 includes an offer ID field 210 into which a unique offer identifier number is populated for identifying a particular offer. The offer ID field 210 may be the index field for the automatic offer table 130.

Associated with the unique offer identifier may be: i) a finance ID field 212 into which identification of a finance company making the offer is populated; ii) a vendor/payee ID field 214 into which identification of a vendor/payee to which the offer is made is populated; iii) an offer date field 216 into which the date the offer is made is populated; iv) a line item number field 218 into which the unique line item number (from line time number field 146 of the line item table 124) against which the offer is made is populated; v) an offered yield field 220 into which a value representing the yield offered to the vendor is populated; vi) an alert field 222 into which a value identifying whether an alert of the offer has been sent to the vendor is populated; vii) an accepted field 224 into which a value identifying whether the offer has been accepted by the vendor is populate; viii) an accepted date field into which a value identifying the date of the vendor's acceptance is populated; and ix) a pay date field 228 into which a date of payment form the finance company to the vendor is made (or is to be made) may be populated.

### Customer/Payer Workflows

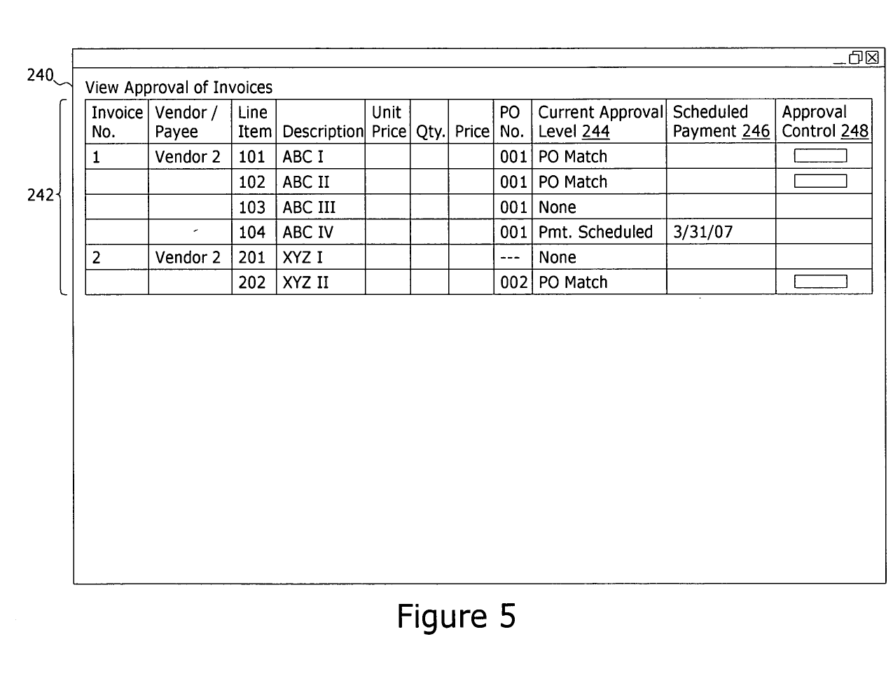

Returning to FIG. 1, as discussed, the session management engine 48 includes customer/payer workflows 50 which facilitate and/or automate the customer/payer's invoice approval and payment processes. In one aspect, the customer/payer workflows 50 enable entitled users of each customer/payer user group to view and approve invoices as depicted in the flow chart of FIG. 4 and the web document diagram of FIG. 5.

Turning to FIG. 4 in conjunction with FIG. 1, step 230 represents extracting qualifying invoices from the database 32. The qualifying invoices will be those invoices stored in the database 32 which are for the customer user group from which the entitled user belongs and meet extraction and/or sort criteria entered by the user such as date range, current approval level, queue for user approval, or other extraction and or sort criteria.

Step 232 represents building and presenting the extracted qualifying invoices, as a web document 240 to the customer/payer system 14.

Referring to FIG. 5, the exemplary web document 240 comprises the invoice data for the qualifying invoices listed as a plurality of rows 242 of a table. To facilitate invoice approval, associated with each invoice line item (represented by a one of the rows 242) may be an indication of the current approval level within a multi-level approval process. Current approval levels may include: i) none—indicating a line item with no approvals; ii) PO Match—indicating the line item has been matched to a purchase order as an initial or threshold level approval; iii) various other approval levels defined by the customer payer based on the type of item being purchased, amount, and other typical invoice approval criteria; and iv) Payment Scheduled—indicating that all approval levels within a multi-level approval process have been satisfied and a payment is scheduled.

Also associated with the line item may be a scheduled payment date field 246 indicating the scheduled date of payment for line items for which payment is scheduled.

Also associated with line item for which the user is entitled to issue the next level of approval within the multi-level approval is an approval control 248. This control enables the user to issue an approval and, when issued, posts the approval to the session management engine 48.

Returning to FIG. 4 in conjunction with FIG. 1, step 234 represents obtaining a post of approvals entered by the user from the customer/payer system 14 and step 236 represents updating the database 32 to represent the posted approvals. In more detail, and briefly referring to FIG. 3c, updating the database 32 may comprise writing a new record to the line item approval table 126 for each posted approval (e.g. writing a value to each field of the line item approval table 126).

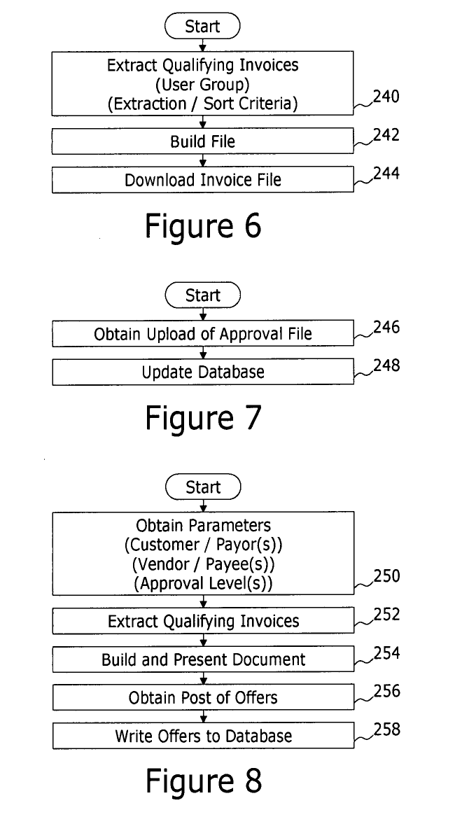

Returning to FIG. 1, also in accordance with the function of facilitating customer/payer approval of invoices, the flow chart of FIG. 6 represents a customer/payer workflow 14 for downloading a file of qualifying invoices from the database 32 and the flow chart of FIG. 7 represents a customer/payer workflow for uploading a file of approval updates for invoices.

Turning to FIG. 6 in conjunction with FIG. 1, step 240 represents extracting qualifying invoices from the database 32. Again, the qualifying invoices will be those invoices stored in the database 32 which are for the customer user group from which the entitled user belongs and meet extraction and/or sort criteria entered by the user such as date range, current approval level, queue for user approval, or other extraction and or sort criteria.

Step 242 represents building a file of the extracted qualifying invoices in a file format defined for the user group and step 244 represents download of the invoice file to the customer/payer system 14.

Turing to FIG. 7 in conjunction with FIG. 1, step 246 represents obtaining upload of an approval file from the customer/payer system 14 and step 248 represents updating the database to represent the approvals. In more detail, and briefly referring to FIG. 3c, updating the database 32 may comprise writing a new record to the line item approval table 126 for each posted approval (e.g. writing a value to each field of the line item approval table 126).

### Finance Company Workflows

Returning to FIG. 1, as discussed, the session management engine 48 includes finance company workflows 54 which enable entitled users of each finance company to perform finance company tasks such as: i) viewing the approval status of submitted invoices and entering factoring offers; and ii) configuring auto factoring parameters for use by the auto factoring offer module 34—which automatically generates factoring offers based on the customer/payer's approval status of an invoice/line item.

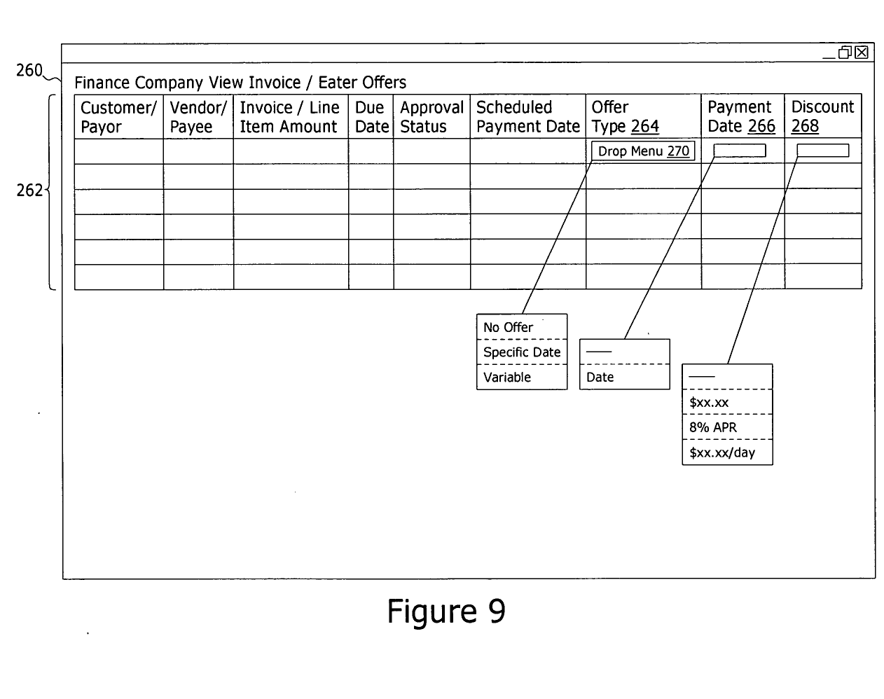

In accordance with the function of viewing the approval status of submitted invoices and entering factoring offers, FIG. 8 is a flow chart representing exemplary operation of the session management engine 48 and FIG. 9 is a web document diagram representing an exemplary web document 160 provided by the session management engine 48 to a finance system 18.

Turning to FIG. 8 in conjunction with FIG. 1, step 250 represents obtaining parameters for invoices to be viewed. Such parameters may include identification of the customer/payer(s) for which the finance company is entitled to view invoices (e.g. as determined from the access table 132 of FIG. 3f), identification of the vendor/payee(s), and minimum approval levels for invoices (e.g. PO Match, Payment Scheduled, and other approval levels within a multi-level approval process).

Step 252 represents extracting qualified invoices from the database 32 which comply with the parameters and step 254 represents building and presenting the line items of the extracted invoices to the finance system 18 as part of a document.

Turning to FIG. 9, the exemplary web document 260, which may be an HTML document, comprises the invoice data for the qualifying invoices listed as a plurality of rows 262 of a table, each row representing a line item of a qualified invoice.

Associated with each line item is an offer type control 264 which enables the user to select an offer type for the factoring offer. The exemplary control is a drop down menu 270 which enable the user to toggle between “no offer”; a “specific pay date offer”, and a “variable pay date offer”.

Also associated with each line item is a pay date control 266. When a “specific pay date offer” is selected by the user, the pay date control 266 is active to enable the user to enter a proposed pay date for the factoring offer.

Also associated with each line item is a discount control 268. The discount control 268 enables the user to select a specific discount payment amount, an annualized interest rate to use for calculating a discount payment amount, or a specific amount (expressed on a per diem basis) to use for calculating a discount payment amount.

Returning to FIG. 8, in conjunction with FIG. 1, step 256 represents obtaining a post of offers entered by the user from the finance system 18 and step 258 represents updating the database 32 to represent the posted offers. In more detail, and briefly referring to FIG. 3g, updating the database 32 may comprise writing a new record to the offer table 134 for each posted offer (e.g. writing a value to each field of the offer table 134).

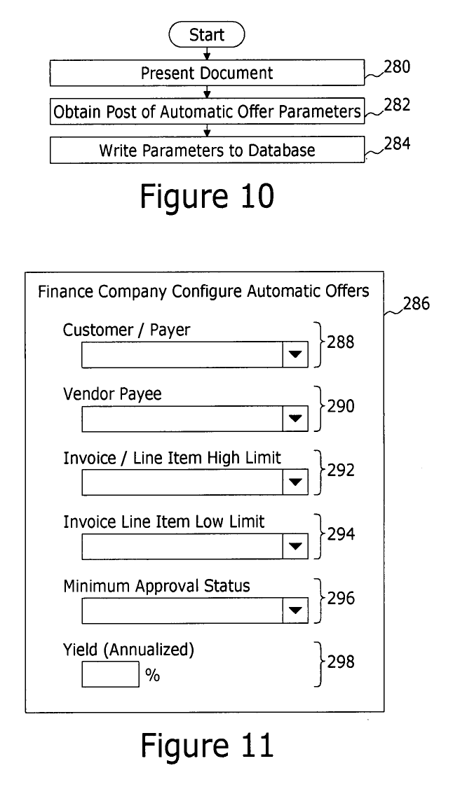

In accordance with the function of configuring auto factoring parameters for use by the auto factoring offer module 34, FIG. 10 is a flow chart representing exemplary operation of the session management engine 48 and FIG. 11 is a diagram representing an exemplary web document 286 provided by the session management engine 48 to a finance system 18 to obtain a post of auto factoring offer parameters.

With reference to FIG. 10 in conjunction with FIG. 1, step 280 represents building and presenting the document 286 to the finance system 18.

With reference to FIG. 11, the exemplary document 286, which may be an HTML document, comprises: i) an customer/payer control 288 which may be a drop down menu to enable the user to select a customer/payer(s) to which the offer will apply; ii) a vendor/payee control 290 which may be a drop down menu to enable the user to select a customer/payer(s) to which the offer will apply; iii) an invoice line item high limit control 292 which may be a control which enables the user to input a maximum line item amount to which the offer will apply; iv) an invoice line item low limit control 294 which may be a control which enables the user to input a minimum line item amount to which the offer will apply; v) a minimum approval status control 296 which may be a drop down menu to enable the user to select the minimum approval status (within a multi level approval system) to which the offer will apply; and vi) yield control 298 which enables the user to input an interest rate (on an annualized basis) to use for calculating offers for line items which meet all parameters of the configured offer.

Returning to FIG. 10 in conjunction with FIG. 1, step 282 represent obtaining a post of the automatic offer parameters entered by the user of the finance system 18 and step 284 represents writing the parameters to the database 32.

In more detail, and briefly referring to FIG. 3e in conjunction with FIG. 1, writing the parameters to the database 32 may comprise writing a new record to the automatic offer table 130—which includes populating each field with values received from the post.

As discussed automatic factoring offer module 34 may automatically generate offers of early payment on invoices (or line items) to the vendor/payee in exchange for a discount based on criteria defined by the finance company. The automatic factoring offer module 34 applies the parameters of each configured offer (e.g. each line item of the automatic offer table 130) to each invoice line item to determine qualified line items—which are items which qualify for the offer (e.g. correct vendor/payee, correct customer/payer, line item amount between the limits, and meeting minimum approval status). An offer is then calculated and recorded in the database 32 (e.g recorded as an offer in the offer table 135 as described in FIG. 3g). The automatic factoring offer module 34 may run on a periodic basis or may run in response to other events such as changed in approval status.

### Vendor/Payee Workflows

Returning to FIG. 1, as discussed, the session management engine 48 includes vendor workflows 52 which enable entitled users of each vendor/payees user group to perform vendor/payee tasks such as viewing the approval status of submitted invoices and viewing/accepting factoring offers made by third party financiers.

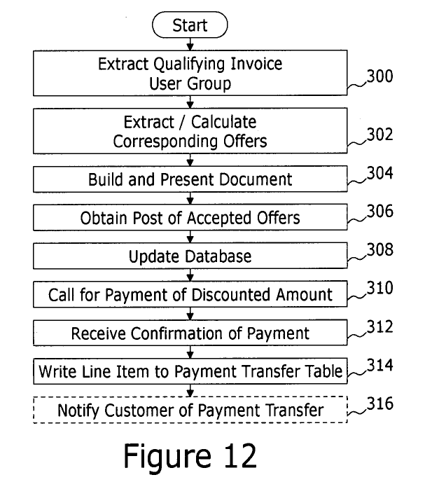

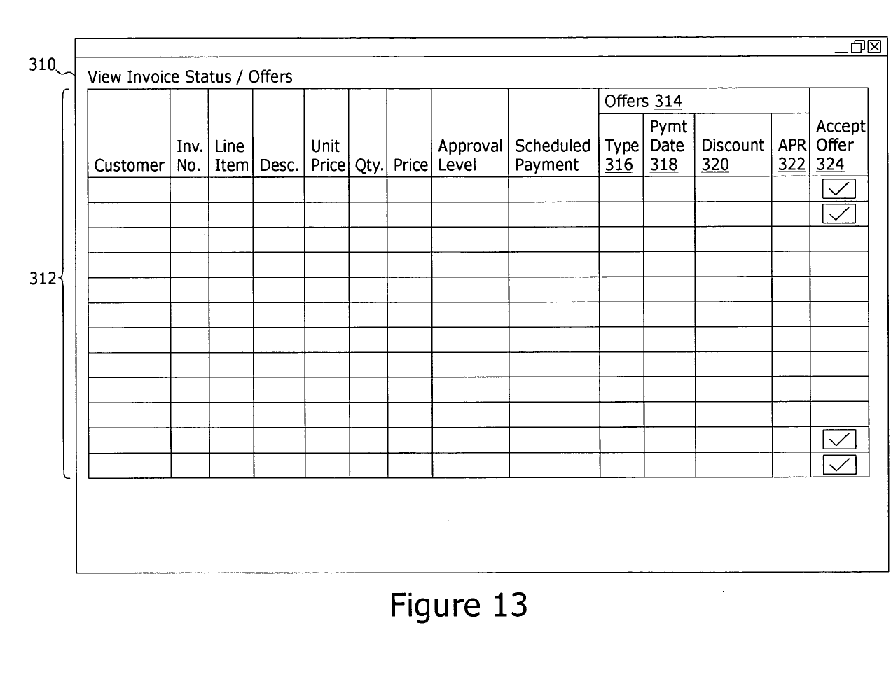

In accordance with this function, FIG. 12 is a flow chart representing exemplary operation of the session management engine 48 and FIG. 13 is a web document diagram representing an exemplary web document 310 provided by the session management engine 48 to a vendor/payee system 16 enable viewing the approval status of submitted invoices and viewing/accepting factoring offers made by third party financiers.

Referring to FIG. 12 in conjunction with FIG. 1, step 300 represent extracting qualified invoices from the database 32. The qualifying invoices/lien items will be those invoices stored in the database 32 which are for the vendor user group from which the entitled user belongs and meet extraction and/or sort criteria entered by the user such as date range.

Step 302 represents extracting offers for the qualified line items of the qualified invoices from the database 32 (e.g records from the offer table 134 of FIG. 3g which include line item numbers (field 218) which match the extracted line item).

Step 304 represents building and presenting the web document 310 to the vendor/payee system 16 (e.g. the client system 30 used by the entitled user for logging onto his or her vendor user access account of the accounts payable automation system 10).

Referring to FIG. 13, the exemplary document 310 comprises the invoice data for the qualifying invoices listed as a plurality of rows 312 of a table. An group of offer field 314 present a factoring offer for those line items which a factoring offer is available. The offer fields may include: i) a type field 316 representing the type of offer (e.g. specific date or variable as discussed with respect to FIG. 9); ii) a pay date field 318 specifying the specific date for payment if a specific date offer or the earliest date for payment if a variable offer; iii) a discount field 320 which may represent a specific discount offered or a specific discounted calculated from the interest rate offered; and iv) an interest rate field 322 which may represent a specific interest rate offered or an interest rate calculated from a specific discount offered.

Also associated with each line item for which a factoring offer is available and for which the user is entitled to accept the offer is an offer acceptance control 324. This control enables the user to select an offer and, when accepted, posts the acceptance to the session management engine 48.

Returning to FIG. 12 in conjunction with FIG. 1, step 306 represents obtaining a post offers accepted by the user from the vendor system 16 and step 308 represents updating the database 32 to represent the accepted offers.

In more detail, and briefly referring to FIG. 3g, updating the database 32 may comprise writing an offer accepted indicator and an acceptance date to the accepted field 224 and the accepted date field 226 of the offer table 134. Updating the database may also comprise, with brief reference to FIG. 3b, calculating the discount and writing the discount and net line item value to the discount field 162 and the net line item field 164 respectively of the line item table 124

Returning to FIG. 12 in conjunction with FIG. 1, step 310 comprises a call to the payment system 38 (or some other remote payment system indicated by the finance company) to generate (or schedule) a payment of the discounted amount. Step 312 represents receiving confirmation of the payment.

Step 314 comprises updating the database to reflect assignment of the receivable to the finance company. In more detail, and with brief reference to FIG. 3d, a new record may be written to the assignment table 128 to reflect the assignment.

Returning to FIG. 12 in conjunction with FIG. 1, step 316 represents notifying the customer/payer of the assignment of the receivable. This may include a call to the email alert system 40.

### Document Image and Workflow System Detail

In general, the document and image file workflow system 56 receives invoice transaction data 68 in the form of document images including paper invoices 70 or electronic invoice image files 60 (e.g. PDF, TIF, TTIFF or similarly formatted image files) and generates invoice data 36 representative of the invoice transaction data 68 therein.

The document and image workflow system 56 may be co-located with the accounts payable automation system 10. Alternatively, the accounts payable automation system 10 may be coupled to multiple document and image workflow systems 56 co-located or located at separate facilities with the data connections being implemented across wide area networks such as the Internet.

In the exemplary embodiment, the document and image file workflow system 56 includes one or more imaging systems 58 for converting the contents of paper invoices 70 to electronic invoice image files 60.

Each imaging system 58 may comprise one or more devices commonly referred to as “Scanners” which image a paper document and generate a PDF, TIF, TIFF, or similarly formatted image file 60.

In the exemplary embodiment, paper invoices 70 are received at a post box uniquely associated with a customer/payer such that the postal employees, by virtue of delivering the mail to the correct post box, sort the invoices by customer/payer. This enables batch imaging of all invoices received for a particular customer/payer without having to perform manual sorting at the scanning facility.

A character recognition system 62 receives each the electronic invoice image file 60 (either as received by the document and image file workflow system 56 or as generated by the imaging system 58 if a paper invoice 70 is received by the document and image file workflow system 56) and converts the invoice data represented by the image file 60 into an electronic invoice transaction data file 64.

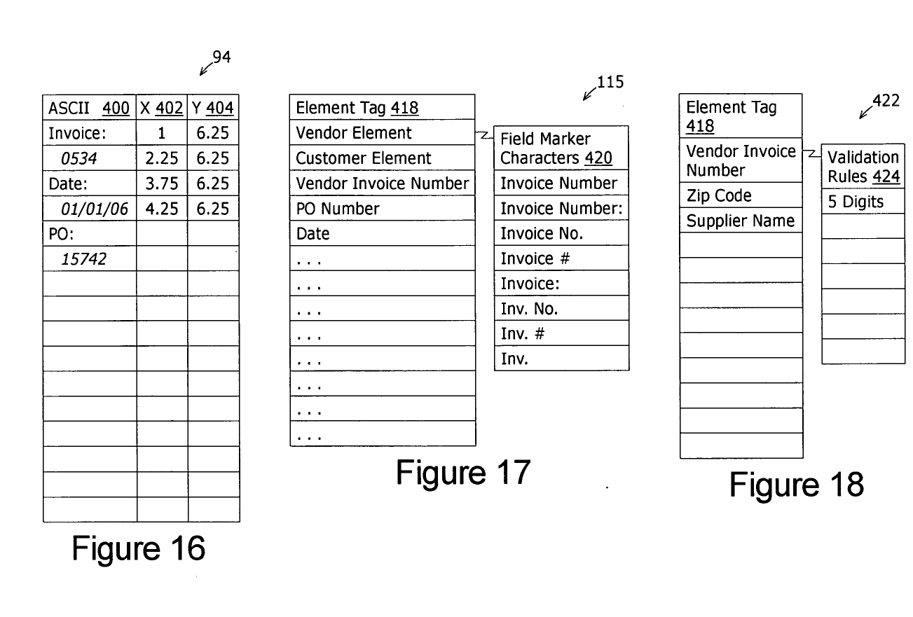

Turning briefly to FIG. 15, an exemplary image file 17 is shown in graphic form. It should be appreciated that the image file 17, in graphic form, appears as the paper invoice 70 which was input to the imaging system 58. The character recognition system 62 recognizes each character in the image and associates the character (or group of characters) with a position within the image. Referring briefly to the table of FIG. 16 in conjunction with FIG. 15, an ASCII value 400 for each recognized character (or the ASCII values for a group of characters recognized) may be associated with a coordinate value 402/404 (within an X/Y Cartesian coordinate system 73 overlaid over the image 17) of the characters location within the image 17.

For example, the word “Invoice:” 406 appears within the image 17 at a certain coordinate (approximately 1, 6.25 in this example). The character recognition system 62 associates the ASCII values for the characters of “Invoice” with the coordinates.

Characters “0534” (reference numeral 408) appear within the image at a certain coordinate (approximately 2.25, 6.25 in this example).

The word “Date:” 410 appears at certain coordinates (approximately 3.75, 6.25 in this example). The character recognition system associates the ASCII values for the characters of “Invoice” with the coordinates.

Characters “Jan. 15, 2006” 412 appear within the image at certain coordinates (approximately 4.25, 6.25 in this example). The character recognition system associates the ASCII values for the characters of “Invoice” with the coordinates.

The characters “PO:” 414 appear at certain coordinates (approximately 5.75, 6.25 in this example). The character recognition system associates the ASCII values for the characters of “Invoice” with the coordinates.

The characters “15742” 416 appear at certain coordinates (approximately 2.25, 6.75, 6.25 in this example). The character recognition system associates the ASCII values for the characters of “Invoice” with the coordinates.

After recognizing characters, the character recognition system 62 generates invoice data 36 by associating data elements recognized within the image 17 with element tags recognized within the image 17.

To perform this process, referring to FIG. 17, the character recognition system 62 identifies, for each element tag 418 that will be used within the invoice data 36 as depicted in FIG. 2, a set of field marker characters 420 which may identify the data element within the image 17. For example, the element tag “Vendor Invoice Number” may be associated with field marker characters such as “Invoice Number” is associated with the following field marker characters “Invoice Number”, “Invoice Number:”, “Invoice No.”, “Invoice #”, “Invoice:”, “Inv. No.”, “Inv. #”, and “Inv:”.

The character recognition system 62 identifies the field marker characters 420 that are within the image file 17. The character recognition system 62 then identifies the data element value to associate with the element tag by identifying the character set located within a field value location. The field value location is a predetermined displacement form the field marker characters associated with the element tag. The predetermined displacement is generally a displacement to the right of the field marker characters 114 or below the field marker characters 114.

For example, referring to FIG. 16 in conjunction with FIG. 15 and FIG. 17, the field marker characters “Invoice:” 406 are associated with the element tag “Vendor Invoice Number” and the characters “0534” are within a predetermined displacement from the field marker characters within the image 17. As such, within the invoice data 36, the data element “0534” is associated with element tag “Vendor Invoice Number”. This process is repeated for all elements of the invoice data 36.

Returning to FIG. 14, because electronic character recognition systems have inherent inaccuracies, a character validation system 66 is used to increase the accuracy of characters within the invoice data 36. The character validation system may comprise a validation engine 66a and a correction center 66b.

The validation engine 66a receives invoice data 36 and applies data field value rules to distinguish between valid data element values and suspect data field values. In more detail, a valid data element value is a value which complies with the validation rule. A suspect data element value is a value which fails to comply with the validation rule.

Turning briefly to FIG. 18, a validation rules database 422 is shown. The validation database 422 associates each data element tag 418 with at least one validation rule 424. For example, a validation rule for applying to the “Vendor Invoice Number” data element may be a rule that requires the data element value to be 5 digits. Therefore a value other than 5 digits would a suspect value.

A validation rule for a supplier or vendor name may be that it matches the name of a supplier or vendor existing in a database. A similar rule may apply to the supplier address. If a data element value of the invoice data 36 is suspect, at least the portion of the invoice data 36 that identifies the suspect data element value and at least a portion of the invoice image file 17 which includes the characters recognized as the suspect data element value are passed to a correction center 66b.

The correction center 66b displays the characters recognized as the suspect data element value in association with the suspect value for a human to manually determine the correct data element value from the image 17 and enter the corrected data element value for replacing the suspect data element value in the invoice data 36.

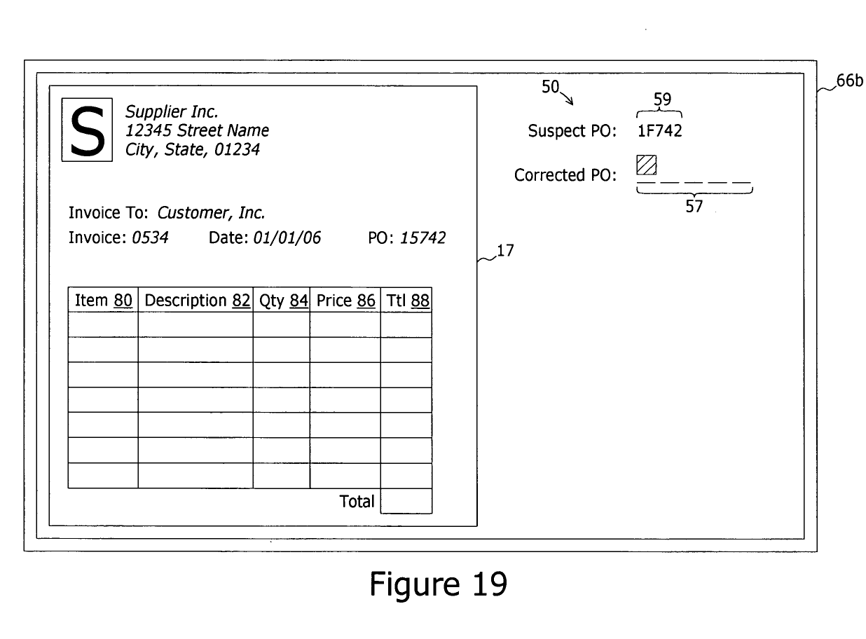

Turning briefly to FIG. 19, in the exemplary embodiment, the correction center 66b includes a display of the invoice image 17 in association with identification 50 of the suspect data element value 59 on a user interface display screen. The correction center 66b may receive, from a human operator via the user interface, a corrected value 57 to replace the suspect value 59.

To further improve accuracy, a correction center 66b may obtain corrected values 57 from two or more independent operators before replacing the suspect data element value in the invoice data 36 with the corrected value—and may make such replacement only if the corrected values 57 entered by each operator match.

After the invoice data 36 is validated (either on initial validation by the validation engine 66a or following correction of suspect fields by the correction center 66b) the validated invoice data 36 is transferred to the loader 38 for loading to the database 32.

### SUMMARY

In summary, the present invention provides for automated analysis of transaction data elements based on rules, automated trending analysis based on evaluation parameters, and automated quantitative analysis based on evaluation functions. All such rules, evaluation parameters, and evaluation functions may be established by the customer/payer to apply to all transactions, or to transactions only from certain vendors.

Although the invention has been shown and described with respect to certain preferred embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of system of the present invention. The present invention includes all such equivalents and modifications, and is limited only by the scope of the following claims.

What is claimed is:

1. An accounts payable automation server system for exchanging invoicing data between a vendor, a customer, and a third party finance company, the accounts system comprising:
an invoice loader receiving invoice data, the invoice data including at least a vendor element and an amount payable element, the vendor element identifying an vendor and the amount payable element identifying consideration payable by the customer to the vendor; and
a session management engine comprising:
customer user access workflows for:
presenting, to a customer system, the invoice data, the customer system being a system controlled by the customer;
finance company user access workflows for:
presenting, to a finance system, the vendor element and the amount payable element;
receiving, from the finance system, an offer of early payment in exchange for a discount of the consideration payable; and
vendor user access workflows for:
presenting, to a vendor system, the offer of early payment in exchange for a discount of the consideration payable; and
receiving an acceptance of the offer from the vendor system; and
the finance company user access workflows further, upon acceptance of the offer, presents, to the finance system, an indication of the acceptance of the offer; and
the session management engine further, upon payment of a discounted amount from the finance company to the vendor, records a direction to transfer payment of the consideration to the finance company.

2. The system of claim 1, wherein the finance company user access workflows further:
present, to the finance system, in association with the vendor element and the amount payable element, a customer approval status indicator identifying an approval status within a multi-tiered approval process.

3. The system of claim 2:
wherein the customer user access workflows further:
receive, from the customer system, an indication of the approval status for association with the vendor element and the amount payable element, and
further comprising an email alert system generating an approval status update email to an email address associated with the finance system, the approval status update email indicating a change of the approval status associated with the vendor element and the amount payable element.

4. The system of claim 2, wherein the customer approval status is a matched-to-purchase-order approval status indicating that the consideration corresponds to the price set forth in a purchase order issued by the customer.

5. The system of claim 4:
wherein the customer user access workflows further receive, from the customer system, an indication of the approval status for association with the vendor element and the amount payable element, and
further comprising an email alert system generating an approval status update email to an email address associated with the finance system, the approval status update email indicating a change of the approval status associated with the vendor element and the amount payable element.

6. The system of claim 4, further comprising:
a purchase order matching system:
receiving purchase order data from the customer system, the purchase order data identifying a plurality of purchase orders issued by the customer; and
comparing the invoice data with the purchase order data to generate the matched-to-purchase-order approval status when the invoice data matches the purchase order data for one of the plurality of purchase orders.

7. The system of claim 6, further comprising:
an email alert system generating an approval status update email to an email address associated with the finance system upon the purchase order matching system generating the matched-to-purchase-order approval status.

8. The system of claim 2, wherein the customer approval status is an approved-for-payment status indicating that the customer has approved a payment in the amount of the consideration.

9. The system of claim 8:
wherein the customer user access workflows further receive, from the customer system, an indication of the approval status for association with the vendor element and the amount payable element; and
further comprising an email alert system generating an approval status update email to an email address associated with the finance system, the approval status update email indicating a change of the approval status associated with the vendor element and the amount payable element.

10. The system of claim 1, further comprising a payment system for generating a payment transaction upon receipt of an acceptance of the offer from the vendor system, the payment transaction comprising an instruction to effect debit from an account corresponding to the finance system of the consideration less the discount and to effect credit to an account corresponding to the vendor system of the consideration less the discount.

11. The system of claim 10, wherein the finance company user access workflows further:
present, to the finance system, in association with the vendor element and the amount payable element, a customer approval status indicator identifying an approval status within a multi-tiered approval process.

12. The system of claim 11:
wherein the customer user access workflows further:
receive, from the customer system, an indication of the approval status for association with the vendor element and the amount payable element, and
further comprising an email alert system generating an approval status update email to an email address associated with the finance system, the approval status update email indicating a change of the approval status associated with the vendor element and the amount payable element.

13. The system of claim 11, wherein the customer approval status is a matched-to-purchase-order approval status indicating that the consideration corresponds to the price set forth in a purchase order issued by the customer.

14. The system of claim 13:
wherein the customer user access workflows further receive, from the customer system, an indication of the approval status for association with the vendor element and the amount payable element, and
further comprising an email alert system generating an approval status update email to an email address associated with the finance system, the approval status update email indicating a change of the approval status associated with the vendor element and the amount payable element.

15. The system of claim 13, further comprising:
a purchase order matching system:
receiving purchase order data from the customer system, the purchase order data identifying a plurality of purchase orders issued by the customer; and
comparing the invoice data with the purchase order data to generate the matched-to-purchase-order approval status when the invoice data matches the purchase order data for one of the plurality of purchase orders.

16. The system of claim 15, further comprising:
an email alert system generating an approval status update email to an email address associated with the finance system upon the purchase order matching system generating the matched-to-purchase-order approval status.

17. The system of claim 11, wherein the customer approval status is an approved-for-payment status indicating that the customer has approved a payment in the amount of the consideration.

18. The system of claim 17, further comprising:
wherein the customer user access workflows further receive, from the customer system, an indication of the approval status for association with the vendor element and the amount payable element; and
further comprising an email alert system generating an approval status update email to an email address associated with the finance system, the approval status update email indicating a change of the approval status associated with the vendor element and the amount payable element.

19. A method of operating an accounts payable automation server with integrated discount and factoring management, method of operating such server comprising:
receiving invoice data, the invoice data including at least a vendor element and an amount payable element, the vendor element identifying an vendor and the amount payable element identifying consideration payable by the customer to the vendor;
presenting, to a customer system, the invoice data, the customer system being a system controlled by the customer;
presenting, to a finance system, the vendor element and the amount payable element;
receiving, from the finance system, an offer of early payment in exchange for a discount of the consideration payable,
presenting to a vendor system, the offer;
receiving an acceptance of the offer from the vendor system;
presenting, to the finance system, an indication of the acceptance of the offer; and
recording a direction to transfer payment of the consideration of the finance company upon payment of the discounted amount from the finance company to the vendor.

20. The method of claim 19, further comprising:
presenting, to the finance system, in association with the vendor element and the amount payable element, a customer approval status indicator identifying an approval status within a multi-tiered approval process.

21. The method of claim 20, further comprising:
upon receiving, from the customer system, an indication of the approval status for association with the vendor element and the amount payable element, generating an approval status update email to an email address associated with the finance system, the approval status update email indicating a change of the approval status associated with the vendor element and the amount payable element.

22. The method of claim 20, wherein the customer approval status is a matched-to-purchase-order approval status indicating that the consideration corresponds to the price set forth in a purchase order issued by the customer.

23. The method of claim 22, further comprising:
upon receiving, from the customer system, an indication of the approval status for association with the vendor element and the amount payable element, generating an approval status update email to an email address associated with the finance system, the approval status update email indicating a change of the approval status associated with the vendor element and the amount payable element.

24. The method of claim 22, further comprising:
receiving purchase order data from the customer system, the purchase order data identifying a plurality of purchase orders issued by the customer; and
comparing the invoice data with the purchase order data to generate the matched-to-purchase-order approval status when the invoice data matches the purchase order data for one of the plurality of purchase orders.

25. The method of claim 24 further comprising:
upon generating the matched-to-purchase-order approval status, generating an approval status update email to an email address associated with the finance system.

26. The method of claim 20, wherein the customer approval status is an approved-for-payment status indicating that the customer has approved a payment in the amount of the consideration.

27. The method of claim 26, further comprising:
upon receiving, from the customer system, an indication of the approval status for association with the vendor element and the amount payable element, generating an approval status update email to an email address associated with the finance system.

28. The method of claim 19, further comprising generating a payment transaction upon receipt of an acceptance of the offer from the vendor system, the payment transaction comprising an instruction to effect debit from an account corresponding to the finance system of the consideration less the discount and to effect credit to an account corresponding to the vendor system of the consideration less the discount.

29. The method of claim 18, further comprising:
presenting, to the finance system, in association with the vendor element and the amount payable element, a customer approval status indicator identifying an approval status within a multi-tiered approval process.

30. The method of claim 29, further comprising:
upon receiving, from the customer system, an indication of the approval status for association with the vendor element and the amount payable element, generating an approval status update email to an email address associated with the finance system.

31. The method of claim 30, wherein the customer approval status is a matched-to-purchase-order approval status indicating that the consideration corresponds to the price set forth in a purchase order issued by the customer.

32. The method of claim 33, further comprising:
upon receiving, from the customer system, an indication of the approval status for association with the vendor element and the amount payable element, generating an approval status update email to an email address associated with the finance system.

33. The method of claim 31, further comprising:
receiving purchase order data from the customer system, the purchase order data identifying a plurality of purchase orders issued by the customer; and
comparing the invoice data with the purchase order data to generate the matched-to-purchase-order approval status when the invoice data matches the purchase order data for one of the plurality of purchase orders.

34. The method of claim 33, further comprising:
upon generating the matched-to-purchase-order approval status, generating an approval status update email to an email address associated with the finance system.

35. The method of claim 30, wherein the customer approval status is an approved-for-payment status indicating that the customer has approved a payment in the amount of the consideration.

36. The method of claim 35, further comprising:
upon receiving, from the customer system, an indication of the approval status for association with the vendor element and the amount payable element, generating an approval status update email to an email address associated with the finance system.
